(19) United States
(12) Patent Application Publication
(10) Pub. No.: US 2025/0107960 A1
(43) Pub. Date: Apr. 3, 2025

(54) Vibrating and Heating Massage Vest

(71) Applicant: Mark Lamar Sistrunk, Oakwood village, OH (US)

(72) Inventor: Mark Lamar Sistrunk, Oakwood village, OH (US)

(21) Appl. No.: 18/979,161

(22) Filed: Dec. 12, 2024

Related U.S. Application Data
(63) Continuation-in-part of application No. 17/521,751, filed on Nov. 8, 2021, now Pat. No. 12,220,372.
(63) Continuation-in-part of application No. 29/971,741, filed on Nov. 5, 2024.
(60) Provisional application No. 63/110,684, filed on Nov. 6, 2020.

(51) Int. Cl. A61H 23/02; A41D 1/04

(52) U.S. Cl. CPC A61H 23/0254; A41D 1/04; A61H 2201/0207; A61H 2201/165; A61H 2201/503; A61H 2205/04; A61H 2205/062; A61H 2205/081

(57) ABSTRACT

A vibrating and heating massage vest is an apparatus that massages and warms the user's upper body for therapeutical purposes on the go. The apparatus includes a vest, a controller, a user interface, a portable power source, a main fastener, several vibrating modules, and several heating elements. The vest retains the rest of the components in a portable manner that is comfortable to wear. The controller and the user interface enable the user to operate the vibrating modules and the heating elements in a practical manner without having to take off the vest. The portable power source enables the apparatus to be utilized on the go without being directly connected to an external power source. The main fastener allows the fastening of the vest to the user's upper body. The vibrating modules and the heating elements enable the therapeutical treatment of the user's upper body to improve the user's health.

The current application is a continuation-in-part (CIP) application of the U.S. non-provisional application Ser. No. 17/521,751 filed on Nov. 8, 2021. The U.S. non-provisional application Ser. No. 17/521,751 claims a priority to the U.S. Provisional Patent application Ser. No. 63/110,684 filed on Nov. 6, 2020.

The current application is also a CIP application of the U.S. non-provisional application Ser. No. 29/971,741 filed on Nov. 5, 2024.

### FIELD OF THE INVENTION

The present invention generally relates to wearable electronic devices and electric body massagers. More specifically, the present invention discloses a massage vest that can be conveniently worn with a snug fit to greatly improve the user's health by massaging and warming up the user's upper body.

### BACKGROUND OF THE INVENTION

Nowadays, several types of wellness and relaxation products are available. Some of the most popular products now available are massage vests. Generally, massage vests are designed to promote blood circulation by massaging various parts of the upper body including the user's neck, shoulders, and back. Many existing massage vests include means to control the speed, local massage functions, and heating temperature. However, these vests are bulky, heavy, and do not include an appealing design because most of the vest's focus is primarily on the massage functionalities. Further, many existing massage vests are not properly designed to provide effective massage to the neck and back of the user. For example, many vests do not allow sufficient contact with the user's body, especially on the lower back, to provide effective massage.

In addition, most massage vests available on the market are not convenient for the user to carry during travel. Many of these massage vests require power connection to an external power source, which can be difficult to find while travelling. Further, most existing wearable massagers are expensive and rarely provide a good fit to the user, often shifting or loosening with use. There is a need for a massage vest that addresses all the issues of existing massage vests.

Therefore, an objective of the present invention is to provide a vibrating and heating massage vest that is portable and comfortable to wear. The present invention is designed to be worn as a traditional vest with a thin structure that can be worn under clothing. Another objective of the present invention is to provide a vibrating and heating massage vest that can be operated on the go. The present invention includes an integrated user interface that can be operated while wearing the massage vest so that the user can engage the massage and heating features without taking off the massage vest. Another objective of the present invention is to provide a vibrating and heating massage vest that can be operated repeatedly without having direct access to an external power source. The present invention includes a portable power source that can be recharged when necessary, so that the massage vest can be used on the go. Additional features and benefits of the present invention are further discussed in the sections below.

### SUMMARY OF THE INVENTION

The present invention discloses a vibrating and heating massage vest designed to provide vibrational therapy and thermotherapy in order to improve the user's health. The present invention is a wearable therapeutical vest that can be worn as a normal vest under other upper body garments. The present invention is designed so that the therapeutical features can be utilized on the go without having to rely on external power sources. To do so, the present invention includes several vibrating modules and heating elements distributed throughout the areas corresponding to the user's neck, shoulders, middle back, and lower back areas. These vibrating modules and heating elements can be selectively engaged to massage and warm the target areas on the user's upper body via a user interface integrated on the vest of the present invention.

The user interface can include, but is not limited to, physical buttons that allow the user to selectively engage the vibrating modules and the heating elements. In addition, the user interface can enable the user to control the intensity of the vibrations and/or heat generated by the vibrating modules and the heating elements, respectively. Further, the present invention includes a portable power source that allows the vibrating modules and the heating elements to be utilized on the go without relying on an external power source. The portable power source of the present invention is preferably a rechargeable battery pack that can be recharged whenever necessary. The portable power source can be designed in such a way that the user can remove the portable power source for recharging. This way, the user can still wear the vest of the present invention without waiting for the portable power source to be charged. Other functional features can be implemented to increase the overall functionality of the present invention.

### BRIEF DESCRIPTION OF THE DRAWINGS

FIG. 1 is top-front-left perspective view of the vest of the present invention.

FIG. 2 is bottom-front-left perspective view of the vest of the present invention.

FIG. 3 is bottom-rear-right perspective view of the vest of the present invention.

FIG. 4 is front view of the vest of the present invention, wherein the vibrating modules, the heating elements, the controller, the portable power source, the wiring harness, and the input connector are shown.

FIG. 5 is rear view of the vest of the present invention, wherein the vibrating modules, the heating elements, and the wiring harness are shown.

FIG. 6 is a schematic view of the at least one pocket of the vest of the present invention, wherein the portable power source is shown connected to the input connector.

FIG. 7 is a box diagram showing the electrical connections and the electronic connections of the present invention, wherein the electrical connections are shown in solid lines, and wherein the electronic connections are shown in dashed lines.

### DETAILED DESCRIPTION OF THE INVENTION

All illustrations of the drawings are for the purpose of describing selected versions of the present invention and are not intended to limit the scope of the present invention.

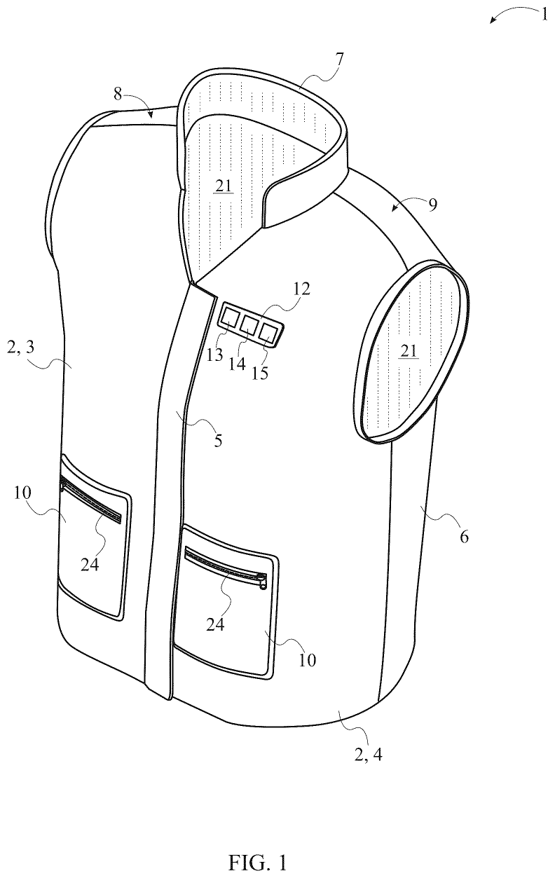

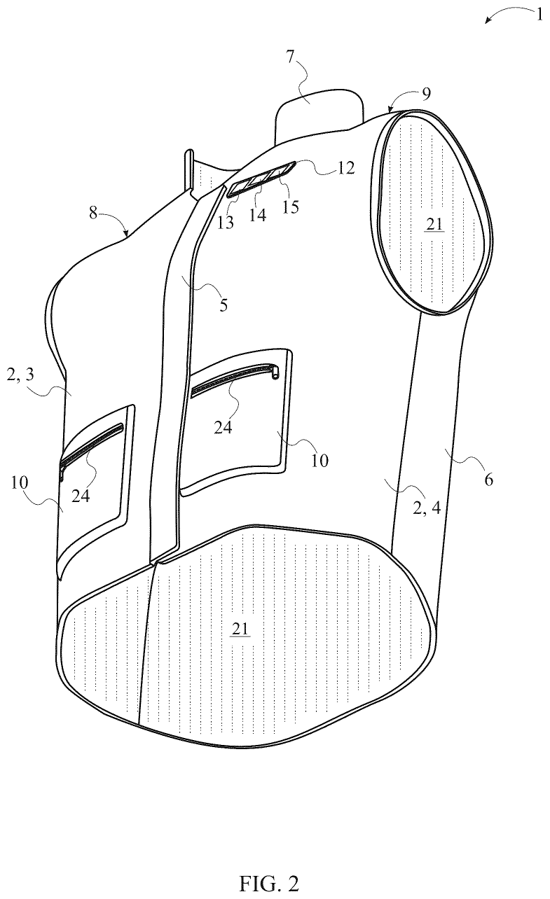

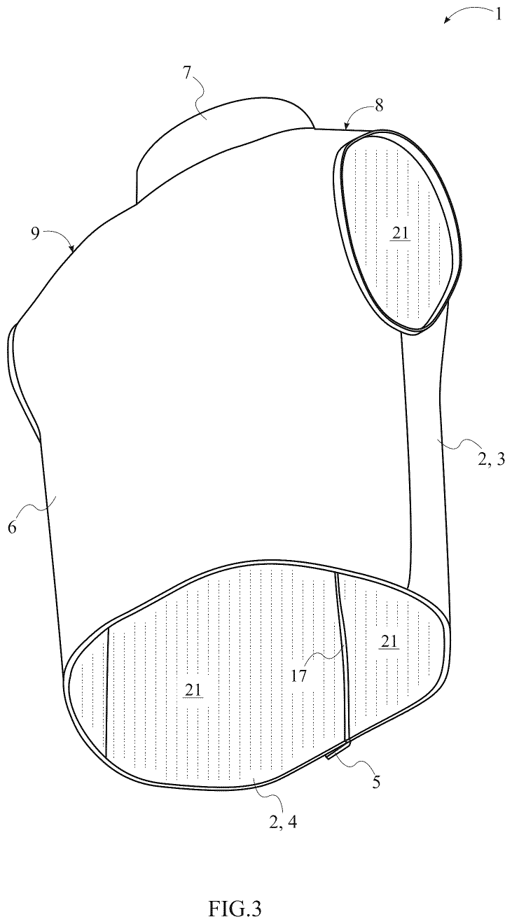

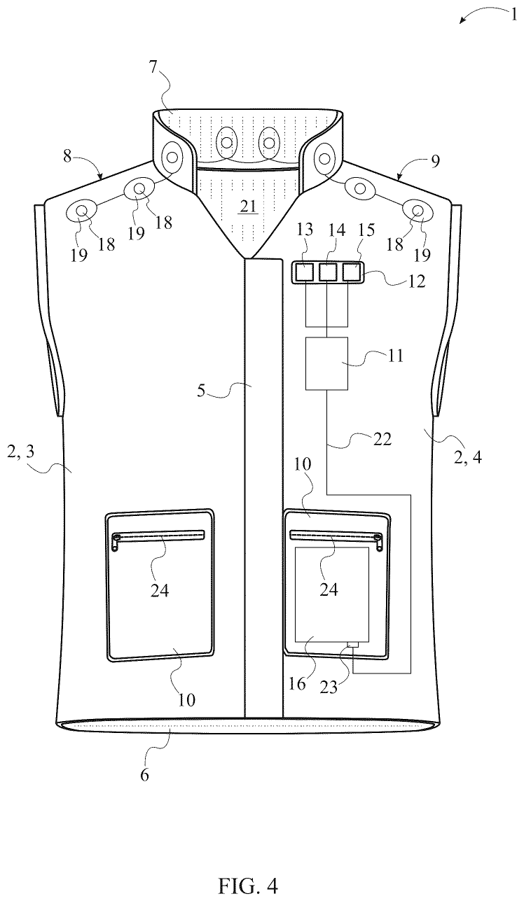

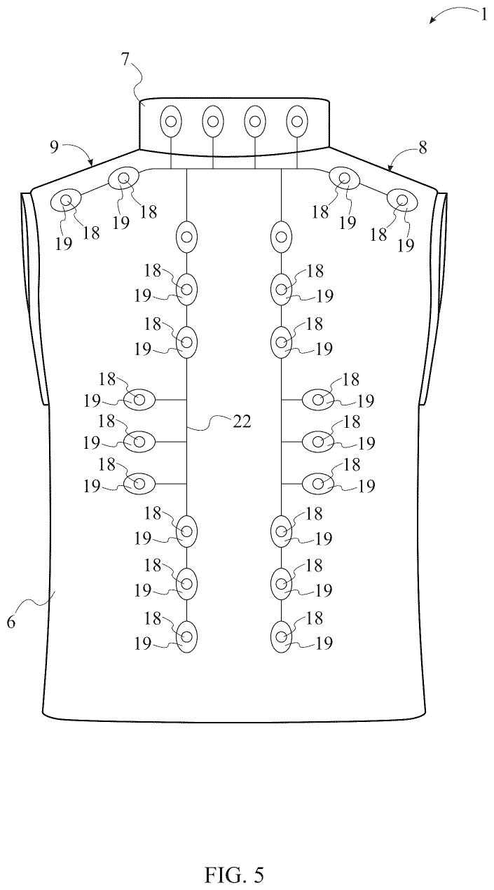

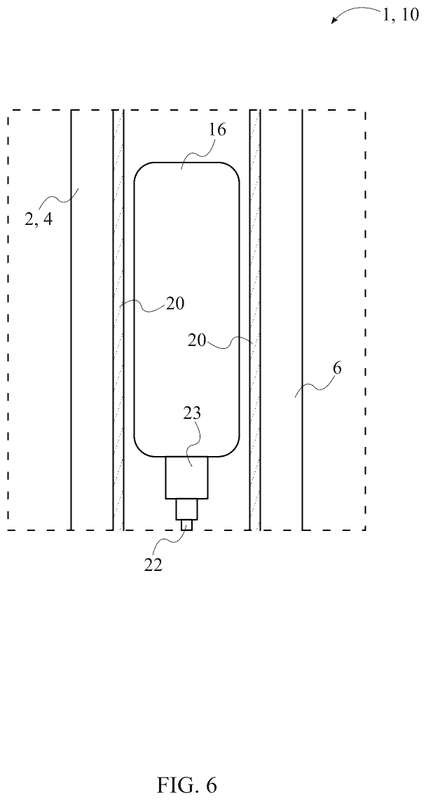

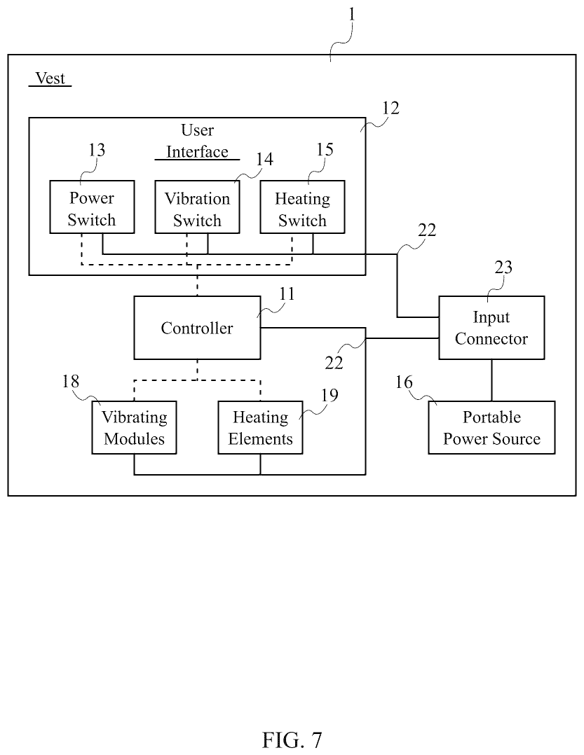

The present invention discloses a vibrating and heating massage vest that can be worn as a normal vest to massage and warm the user's upper body for therapeutical purposes on the go. As can be seen in FIGS. 1 through 7, the present invention comprises a vest 1, a controller 11, a user interface 12, a portable power source 16, at least one main fastener 17, a plurality of vibrating modules 18, and a plurality of heating elements 19. The vest 1 corresponds to the main structure of the present invention that retains the rest of the components in a portable manner that is comfortable to wear. The controller 11 and the user interface 12 enable the user to operate the plurality of vibrating modules 18 and the plurality of heating elements 19 in a practical manner without having to take off the vest 1. The portable power source 16 enables the present invention to be utilized on the go without being directly connected to an external power source. The at least one main fastener 17 allows the fastening of the vest 1 to the user's upper body. The plurality of vibrating modules 18 and the plurality of heating elements 19 enable the therapeutical treatment of the user's upper body to improve the user's health.

The general configuration of the aforementioned components enables the user to receive vibrational therapy and thermotherapy while wearing comfortable clothing. As previously discussed, the vest 1 is designed as a traditional vest that can be worn with other upper body garments comfortably. As can be seen in FIGS. 1 through 7, the overall shape and size of the vest 1 can be altered to match the user's body and can come with different ornamental designs. In general, the vest 1 comprises a front 2, a back 6, a collar 7, a first shoulder 8, a second shoulder 9, and at least one pocket 10, The front 2 corresponds to the section of the vest 1 that covers the user's chest and stomach, while the back 6 covers the user's back. The collar 7 corresponds to the section of the vest 1 that covers the user's neck, while the first shoulder 8 and the second shoulder 9 cover the user's shoulders. The at least one pocket 10 serves to retain small items as well as the portable power source 16 so that the portable power source 16 can be easily removed for recharging. Further, the front 2 of the vest 1 comprises a first side piece 3, a second side piece 4, and an overlapping flap 5. The first side piece 3 and the second side piece 4 correspond to two sections that can be selectively connected together to fully cover the user's stomach and chest. The overlapping flap 5 covers the location along which the first side piece 3 is connected to the second side piece 4.

In the preferred embodiment, the present invention can be arranged as follows: the collar 7 is terminally attached to the back 6 to secure the collar 7 to the back 6, as can be seen in FIGS. 1 through 7. The overall size of the collar 7 can be altered to cover different areas of the user's neck. The first shoulder 8 and the second shoulder 9 are positioned on the back 6, adjacent to the collar 7, to match the anatomical arrangement of the user's shoulders. Further, the first side piece 3 is connected along and adjacent to the back 6 to secure the first side piece 3 to the back 6. Similarly, the second side piece 4 is connected along and adjacent to the back 6, opposite to the first side piece 3, to also connect the second side piece 4 to the back 6. Further, the overlapping flap 5 is connected along and adjacent to the first side piece 3, opposite to the back 6, to secure the overlapping flap 5 to the first side piece 3. In addition, the overlapping flap 5, the first side piece 3, the back 6, and the second side piece 4 are preferably a continuous piece of material. However, in different embodiments, the individual sections of the vest 1 can be made from separate pieces of material that are attached to each other using the appropriate methods including, but not limited to, sewing, gluing, etc. Further, for the vest 1 to be secured to the user's upper body, the overlapping flap 5 is laid over the second side piece 4 to position the free lateral edges of the side pieces adjacent to each other. Then, the first side piece 3 can be attached to the second side piece 4 by the at least one main fastener 17. The at least one main fastener 17 is preferably zipper that runs from the collar 7 to the hem of the vest 1. However, other fasteners such as hook-and-loop fasteners can be implemented. Furthermore, the at least one pocket 10 is integrated into the front 2, offset from the collar 7, so that the at least one pocket 10 can be accessed from the exterior of the vest 1.

As previously discussed, the electrical components and the electronic components are integrated into the vest 1 in such a way that the vest 1 can be comfortably worn by the user for long periods of time. As can be seen in FIGS. 1 through 7, the plurality of vibrating modules 18 is integrated throughout the collar 7, the first shoulder 8, the second shoulder 9, and the back 6 so that the plurality of vibrating modules 18 can massage the user's necks, shoulders, and back. In the preferred embodiment, each of the plurality of vibrating modules 18 is designed as a low-profile device that can generate safe vibrations to massage the adjacent body area. For example, each of the plurality of vibrating modules 18 can be a flat-coin vibration motor. However, different low-profile vibrating devices can be implemented. Further, each of the plurality of vibrating modules 18 is perimetrically encircled by a corresponding heating element from the plurality of heating elements 19. This way, each vibrating module and the corresponding heating element can massage and warm up the adjacent body area simultaneously. Each of the plurality of heating elements 19 is preferably a safe heating device capable of emitting heat without hurting the user's body. Further, the controller 11 is preferably integrated into the second side piece 4 so that the controller 11 is isolated from the external environment. The controller 11 is preferably a microcontroller 11 that does not cause discomfort when the vest 1 is being worn.

On the other hand, the user interface 12 is externally connected onto the second side piece 4, adjacent to the collar 7 and the second shoulder 9, so that the user interface 12 can be accessed by the user. As can be seen in FIGS. 1 through 7, the user interface 12 is also positioned close to the controller 11 to minimize the wiring necessary but different arrangements can be implemented if necessary for different vest 1 designs. Further, the portable power source 16 is positioned within the at least one pocket 10 so that the portable power source 16 can be carried on the vest 1 comfortably. The portable power source 16 is preferably a portable power pack that can be recharged whenever necessary. Alternate designs may allow the portable power source 16 to be stored in different locations on the vest 1, such as an interior pocket of the vest 1. Furthermore, the controller 11 is electronically connected to the plurality of vibrating modules 18, the plurality of heating elements 19, and the user interface 12. This way, the user input from the user interface 12 can be processed by the controller 11 and the appropriate command signals can be transmitted to the appropriate components. The portable power source 16 is also electrically connected to the controller 11, the plurality of vibrating modules 18, the plurality of heating elements 19, and the user interface 12 to transmit the electricity necessary for the operation of the electrical components. In other embodiments, different components can be implemented to facilitate the safe and comfortable operation of the present invention on the go.

As previously discussed, the user interface 12 allows the user to comfortably and easily control the operation of the plurality of vibrating modules 18 and the plurality of heating elements 19 while wearing the vest 1. As can be seen in FIGS. 1 through 7, the user interface 12 is designed to include several control features that give the user greater control over the operation of the plurality of vibrating modules 18 and the plurality of heating elements 19. In the preferred embodiment, the user interface 12 comprises a power switch 13, a vibration switch 14, and a heating switch 15. The power switch 13 enables the user to engage the overall therapeutic system of the vest 1 so that the user can selectively activate the plurality of vibrating modules 18 and/or the plurality of heating elements 19. The vibration switch 14 enables the selective activation of the plurality of vibrating modules 18 as well as the control of the intensity of the vibrations generated by the plurality of vibrating modules 18. For example, the vibration switch 14 can be used to cycle through a series of increasing vibration intensities by consecutively pressing the vibration switch 14. Similarly, the heating switch 15 enables the selective activation of the plurality of heating elements 19 as well as the control of the intensity of the heat generated by the plurality of heating elements 19. For example, the heating switch 15 can be used to cycle through a series of increasing temperature intensities by consecutively pressing the heat switch. Furthermore, the power switch 13, the vibration switch 14, and the heating switch 15 are serially positioned along the user interface 12 for case of operation. In other embodiments, different control features can be implemented to help the user control the operation of the plurality of vibrating modules 18 and/or the plurality of heating elements 19.

As can be seen in FIGS. 1 through 7, the vest 1 of the present invention is designed to be comfortably worn without risk of harm to the user while the plurality of heating elements 19 is activated. To do so, the present invention may further comprise a silver-impregnated lining 20 that can be used to isolate the portable power source 16 from the plurality of heating elements 19 as well as other environmental factors that may damage the portable power source 16. The silver-impregnated lining 20 is connected within the at least one pocket 10 to cover the interior of the at least one pocket 10. This way, the portable power source 16 is protected by the silver-impregnate lining when stored within the at least one pocket 10.

Similar to the silver-impregnated lining 20, the present invention may further comprise a thermally-conductive lining 21 that separates the user's body from the plurality of heating elements 19 to prevent harm to the user's body, as can be seen in FIGS. 1 through 7. The thermally-conductive lining 21 is designed to allow heat generated by the plurality of heating elements 19 to flow into the user's body while preventing direct contact with the user's skin. To do so, the thermally-conductive lining 21 is connected within the vest 1 and across the first side piece 3, the second side piece 4, and the back 6. This way, when the user is wearing the vest 1, the user's body is protected by the thermally-conductive lining 21 without making the user uncomfortable. In other embodiments, the present invention may include other safety measures that protect the user without hindering the operation of the plurality of heating elements 19 nor the plurality of vibrating modules 18.

As can be seen in FIGS. 1 through 7, to help the vest 1 maintain an overall low profile, the present invention may further comprise a wiring harness 22 that allows the secure electrical connection of the different electrical components. In addition, the wiring harness 22 can comprise an input connector 23 that facilitates the removable connection of the portable power source 16. The input connector 23 is power connector that matches the design of the portable power source 16. For example, the input connector 23 can be a Universal Serial Bus (USB) connector or other similar power connectors. To incorporate the wire harness and the input connector 23, the wiring harness 22 is integrated into the vest 1 so that the wiring harness 22 is isolated from the surroundings. In addition, the wiring harness 22 is electrically connected to the controller 11, the plurality of vibrating modules 18, the plurality of heating elements 19, and the user interface 12 to distribute the electricity from the portable power source 16 to the different electrical components. Further, the input connector 23 traverses into the at least one pocket 10 so that the input connector 23 is accessible within the at least one pocket 10. Lastly, the portable power source 16 is electrically attached to the input connector 23 to connect the portable power source 16 to the wiring harness 22. In other embodiments, different portable power systems can be implemented.

In some embodiments, the present invention may further comprise at least one ancillary fastener 24 that enables the user to selectively close the at least one pocket 10, as can be seen in FIGS. 1 through 7. The at least one ancillary fastener 24 prevents access into the at least one pocket 10 while also preventing the portable power source 16 from falling out of the at least one pocket 10. To do so, the at least one ancillary fastener 24 is connected along an opening of the at least one pocket 10. For example, the at least one ancillary fastener 24 can be a zipper that can be manually engaged to open/close the at least one pocket 10. In other embodiments, different fasteners can be implemented to help the user selectively open/close the at least one pocket 10.

Although the invention has been explained in relation to its preferred embodiment, it is to be understood that many other possible modifications and variations can be made without departing from the spirit and scope of the invention as hereinafter claimed.

What is claimed is:

1. A vibrating and heating massage vest comprising:
a vest;
a controller;
a user interface;
a portable power source;
at least one main fastener;
a plurality of vibrating modules;
a plurality of heating elements;
the vest comprising a front, a back, a collar, a first shoulder, a second shoulder, and at least one pocket;
the front comprising a first side piece, a second side piece, and an overlapping flap;
the collar being terminally attached to the back;
the first shoulder and the second shoulder being positioned on the back, adjacent to the collar;
the first side piece being connected along and adjacent to the back;
the second side piece being connected along and adjacent to the back, opposite to the first side piece;
the overlapping flap being connected along and adjacent to the first side piece, opposite to the back;
the overlapping flap, the first side piece, the back, and the second side piece being a continuous piece of material;
the overlapping flap being laid over the second side piece;
the first side piece being attached to the second side piece by the at least one main fastener;
the at least one pocket being integrated into the front, offset from the collar;
the plurality of vibrating modules being integrated throughout the collar, the first shoulder, the second shoulder, and the back;
each of the plurality of vibrating modules being perimetrically encircled by a corresponding heating element from the plurality of heating elements;
the controller being integrated into the second side piece;
the user interface being externally connected onto the second side piece, adjacent to the collar and the second shoulder;
the portable power source being positioned within the at least one pocket;
the controller being electronically connected to the plurality of vibrating modules, the plurality of heating elements, and the user interface; and
the portable power source being electrically connected to the controller, the plurality of vibrating modules, the plurality of heating elements, and the user interface.

2. The vibrating and heating massage vest as claimed in claim 1 further comprising:
the user interface comprising a power switch, a vibration switch, and a heating switch; and
the power switch, the vibration switch, and the heating switch being serially positioned along the user interface.

3. The vibrating and heating massage vest as claimed in claim 2, wherein the vibration switch is used to cycle through a series of increasing vibration intensities by consecutively pressing the vibration switch.

4. The vibrating and heating massage vest as claimed in claim 2, wherein the heating switch is used to cycle through a series of increasing temperature intensities by consecutively pressing the heat switch.

5. The vibrating and heating massage vest as claimed in claim 1 further comprising:
a silver-impregnated lining; and
the silver-impregnated lining being connected within the at least one pocket.

6. The vibrating and heating massage vest as claimed in claim 1 further comprising:
a thermally-conductive lining; and
the thermally-conductive lining being connected within the vest and across the first side piece, the second side piece, and the back.

7. The vibrating and heating massage vest as claimed in claim 1 further comprising:
a wiring harness;
the wiring harness comprising an input connector;
the wiring harness being integrated into the vest;
the wiring harness being electrically connected to the controller, the plurality of vibrating modules, the plurality of heating elements, and the user interface;
the input connector traversing into the at least one pocket; and
the portable power source being electrically attached to the input connector.

8. The vibrating and heating massage vest as claimed in claim 1, wherein each of the plurality of vibrating modules is a flat-coin vibration motor.

9. The vibrating and heating massage vest as claimed in claim 1, wherein the at least one main fastener is a zipper.

10. The vibrating and heating massage vest as claimed in claim 1 further comprising:
at least one ancillary fastener; and
the at least one ancillary fastener being connected along an opening of the at least one pocket.

11. The vibrating and heating massage vest as claimed in claim 10, wherein the at least one ancillary fastener is a zipper.

12. A vibrating and heating massage vest comprising:
a vest;
a controller;
a user interface;
a portable power source;
at least one main fastener;
a plurality of vibrating modules;
a plurality of heating elements;
the vest comprising a front, a back, a collar, a first shoulder, a second shoulder, and at least one pocket;
the front comprising a first side piece, a second side piece, and an overlapping flap;
each of the plurality of vibrating modules being a flat-coin vibration motor;
the at least one main fastener being a zipper;
the collar being terminally attached to the back;
the first shoulder and the second shoulder being positioned on the back, adjacent to the collar;
the first side piece being connected along and adjacent to the back;
the second side piece being connected along and adjacent to the back, opposite to the first side piece;
the overlapping flap being connected along and adjacent to the first side piece, opposite to the back;
the overlapping flap, the first side piece, the back, and the second side piece being a continuous piece of material;
the overlapping flap being laid over the second side piece;
the first side piece being attached to the second side piece by the at least one main fastener;
the at least one pocket being integrated into the front, offset from the collar;
the plurality of vibrating modules being integrated throughout the collar, the first shoulder, the second shoulder, and the back;
each of the plurality of vibrating modules being perimetrically encircled by a corresponding heating element from the plurality of heating elements;
the controller being integrated into the second side piece;
the user interface being externally connected onto the second side piece, adjacent to the collar and the second shoulder;
the portable power source being positioned within the at least one pocket;
the controller being electronically connected to the plurality of vibrating modules, the plurality of heating elements, and the user interface; and
the portable power source being electrically connected to the controller, the plurality of vibrating modules, the plurality of heating elements, and the user interface.

13. The vibrating and heating massage vest as claimed in claim 12 further comprising:
the user interface comprising a power switch, a vibration switch, and a heating switch; and
the power switch, the vibration switch, and the heating switch being serially positioned along the user interface.

14. The vibrating and heating massage vest as claimed in claim 13, wherein the vibration switch is used to cycle through a series of increasing vibration intensities by consecutively pressing the vibration switch.

15. The vibrating and heating massage vest as claimed in claim 13, wherein the heating switch is used to cycle through a series of increasing temperature intensities by consecutively pressing the heat switch.

16. The vibrating and heating massage vest as claimed in claim 12 further comprising:
a silver-impregnated lining; and
the silver-impregnated lining being connected within the at least one pocket.

17. The vibrating and heating massage vest as claimed in claim 12 further comprising:
a thermally-conductive lining; and
the thermally-conductive lining being connected within the vest and across the first side piece, the second side piece, and the back.

18. The vibrating and heating massage vest as claimed in claim 12 further comprising:
a wiring harness;
the wiring harness comprising an input connector;
the wiring harness being integrated into the vest;
the wiring harness being electrically connected to the controller, the plurality of vibrating modules, the plurality of heating elements, and the user interface;
the input connector traversing into the at least one pocket; and
the portable power source being electrically attached to the input connector.

19. The vibrating and heating massage vest as claimed in claim 12 further comprising:
at least one ancillary fastener; and
the at least one ancillary fastener being connected along an opening of the at least one pocket.

20. The vibrating and heating massage vest as claimed in claim 19, wherein the at least one ancillary fastener is a zipper.
